(19) United States
(12) Patent Application Publication
(10) Pub. No.: US 2015/0247738 A1
(43) Pub. Date: Sep. 3, 2015

(54) INFORMATION PROCESSING SYSTEM, SERVER, AND IMAGE FORMING APPARATUS

(71) Applicant: KYOCERA Document Solutions Inc., Osaka (JP)

(72) Inventor: Takanori SHIRAISHI, Osaka (JP)

(73) Assignee: KYOCERA Document Solutions Inc., Osaka (JP)

(21) Appl. No.: 14/630,954

(22) Filed: Feb. 25, 2015

(30) Foreign Application Priority Data
Feb. 28, 2014 (JP) 2014-037743

(51) Int. Cl. G01C 21/36; G01C 21/34

(52) U.S. Cl. CPC G01C 21/3641; G01C 21/3664; G01C 21/3679; G01C 21/343

(57) ABSTRACT

A server is communicable with at least one terminal used by a traveler and generates guidebook data of a guidebook for display or printing by the terminal The server includes a reception section, a guidebook data generating section, and a transmission section. The reception section receives, from the terminal, basic information pertaining to a trip being planned by the traveler and characteristic information indicating a characteristic of the traveler. The guidebook generating section prepares one or more travel plans that are appropriate for the traveler based on the basic information and the characteristic information received from the terminal, and based on reference information acquired from at least one external server. The guidebook generating section generates guidebook data of a guidebook indicating each of the travel plans prepared thereby. The transmission section transmits the generated guidebook data to the terminal.

### INCORPORATION BY REFERENCE

The present application claims priority under 35 U.S.C. §119 to Japanese Patent Application No. 2014-037743, filed Feb. 28, 2014. The contents of this application are incorporated herein by reference in their entirety.

### BACKGROUND

The present disclosure relates to an information processing system, a server, and an image forming apparatus for providing a guidebook to a traveler.

A technique is known for providing cyberspace to a traveler as an individual storage region for the traveler and effectively using the provided cyberspace. In one example, a travel service system stores travel information in cyberspace of a traveler. The travel information is for example public transport information or information pertaining to restaurants in proximity to a station. The travel service system notifies the traveler that the travel information has been stored in the cyberspace.

### SUMMARY

An information processing system according to one aspect of the present disclosure includes at least one terminal used by a traveler, a first server, and at least one second server. The first server is communicable with the terminal and generates guidebook data of a guidebook for display or printing by the terminal. The second server is communicable with the first server and provides reference information for reference during generation of the guidebook data. The first server includes a server reception section, a guidebook data generating section, and a server transmission section. The server reception section receives, from the terminal, basic information pertaining to a trip being planned by the traveler and characteristic information indicating a characteristic of the traveler. The guidebook data generating section prepares one or more travel plans for the trip that are appropriate for the traveler based on the basic information and the characteristic information received from the terminal, and based on the reference information acquired from the second server. The guidebook data generating section generates guidebook data of a guidebook indicating each of the travel plans. The server transmission section transmits the guidebook data generated by the guidebook data generating section to the terminal.

A server according to another aspect of the present disclosure is communicable with at least one terminal used by a traveler and generates guidebook data of a guidebook for display or printing by the terminal. The server includes a reception section, a guidebook data generating section, and a transmission section. The reception section receives, from the terminal, basic information pertaining to a trip being planned by the traveler and characteristic information indicating a characteristic of the traveler. The guidebook data generating section prepares one or more travel plans for the trip that are appropriate for the traveler based on the basic information and the characteristic information received from the terminal, and based on reference information acquired from at least one external server. The guidebook data generating section generates guidebook data of a guidebook indicating each of the travel plans. The transmission section transmits the guidebook data generated by the guidebook data generating section to the terminal.

An image forming apparatus according to another aspect of the present disclosure includes an input section, a transmission section, a reception section, and a printing section. The input section receives input of basic information pertaining to a trip being planned by a traveler and characteristic information indicating a characteristic of the traveler. The transmission section transmits the basic information and the characteristic information to a first server. The reception section receives, from the first server, guidebook data of a guidebook indicating one or more travel plans that are appropriate for the traveler and that have been prepared by the first server based on the basic information and the characteristic information, and based on reference information acquired from at least one second server. The printing section prints the guidebook based on the guidebook data that is received.

### BRIEF DESCRIPTION OF THE DRAWINGS

FIG. 1 is a configurational diagram illustrating an example of an information processing system according to an embodiment.

FIG. 2 is a configurational diagram illustrating an example of a mobile terminal according to an embodiment.

FIG. 3 is a configurational diagram illustrating an example of an image forming apparatus according to an embodiment.

FIG. 4 is a configurational diagram illustrating an example of a guidebook generating server according to an embodiment.

FIG. 5 is a configurational diagram illustrating an example of a guidebook according to an embodiment.

FIG. 6 is a flowchart illustrating a first example of a guidebook generation process according to an embodiment.

FIG. 7 is a flowchart illustrating a second example of a guidebook generation process according to an embodiment.

FIG. 8 is a flowchart illustrating a first example of a guidebook reacquisition process according to an embodiment.

FIG. 9 is a flowchart illustrating a second example of a guidebook reacquisition process according to an embodiment.

FIG. 10 is a flowchart illustrating a guidebook update process according to an embodiment.

### DETAILED DESCRIPTION

The following explains an embodiment of the present disclosure with reference to the drawings. Note that the embodiment explained below does not in any way limit the present disclosure as relating to the Claims. Also note that not all of the elements and combinations thereof explained in the embodiment are essential for achieving the problem-solving effects of the present disclosure. Reference signs that are used in a plurality of different drawings indicate the same element in each of the drawings.

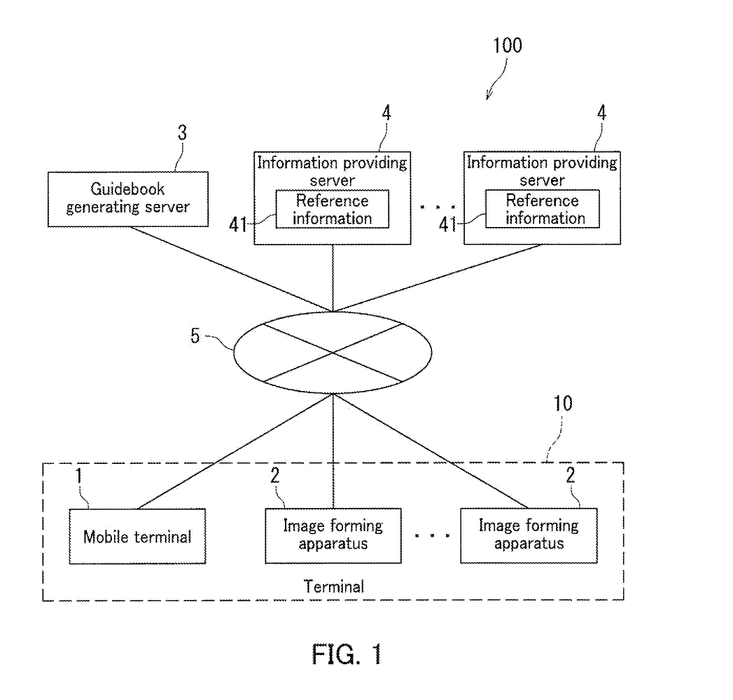

FIG. 1 is a configurational diagram illustrating an example of an information processing system according to the embodiment.

An information processing system 100 provides a traveler with a guidebook that is appropriate for the traveler. In other words, the information processing system 100 provides the traveler with a guidebook that is customized for the traveler. The information processing system 100 includes at least one terminal 10, a guidebook generating server 3, and one or more information providing servers 4. The terminal 10, the guidebook generating server 3, and the information providing servers 4 are connected to one another via a communication network 5. The communication network 5 is for example the Internet or a local area network (LAN). The guidebook generating server 3 is communicable with the terminal 10 and each of the information providing servers 4 via the communication network 5. Note that a communication network through which the guidebook generating server 3 communicates with the terminal 10 may be a different network to a communication network through which the guidebook generating server 3 communicates with the information providing servers 4.

The terminal 10 is a device operated by the traveler and is for example a mobile terminal 1 or an image forming apparatus 2. In the present embodiment, the information processing system 100 includes one mobile terminal 1 and at least one image forming apparatus 2 as terminals 10. The image forming apparatus 2 is for example provided along a route (referred to below as a “travel route”) between a start point and a final destination point of a trip being planned by the traveler. In the following explanation the term “trip” is used to refer to the trip that is being planned by the traveler, the term “start point” is used to refer to the start point of the trip, and the term “final destination point” is used to refer to the final destination point of the trip.

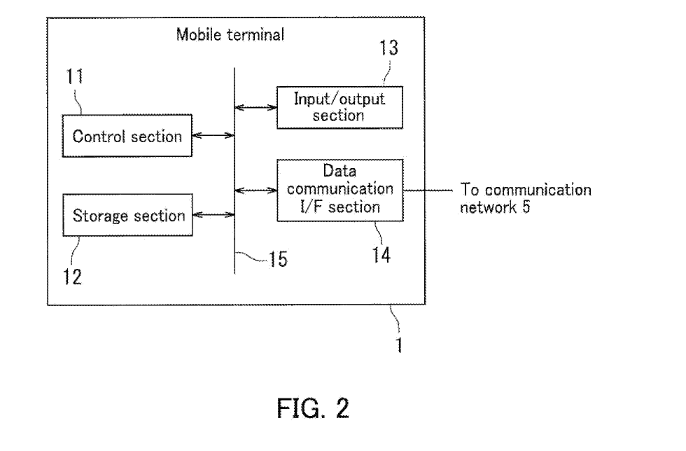

The guidebook generating server 3 generates guidebook data of a guidebook for display or printing by the terminals 10. Each of the information providing servers 4 provides various types of information to a device with respect to which the information providing server 4 is accessible. The information providing server 4 is for example a Web server that makes various types of information (Web pages) publicly available over the communication network 5. In the present embodiment, the term “reference information” is used to refer to information that the guidebook generating server 3 refers to during generation of guidebook data from among all information provided by the information providing servers 4. Examples of reference information 41 include information indicating a map of a given area, information indicating a tourist attraction, shop, or restaurant (referred to below as an “attraction”) located in a given area, information indicating an event to be held at an attraction in a given area during a given period, and information indicating weather in a given area during a given period. The following explains configuration of the mobile terminal 1, the image forming apparatus 2, and the guidebook generating server 3 with reference to FIGS. 2-4.

FIG. 2 is a configurational diagram illustrating an example of a mobile terminal according to the embodiment.

The mobile terminal 1 is for example a smart phone or a mobile personal computer (PC). The mobile terminal 1 includes a control section 11, a storage section 12, an input/output section 13 (input section and displaying section), and a data communication interface (I/F) section 14 (terminal transmission section). The control section 11, the storage section 12, the input/output section 13, and the data communication I/F section 14 are connected to one another via an internal bus 15.

The control section 11 controls operation of the mobile terminal 1. The storage section 12 includes read only memory (ROM), random access memory (RAM), and a secondary storage device. The secondary storage device is for example a non-volatile storage device such as a hard disk or flash memory. The input/output section 13 is a device that implements functions of input and output. The input/output section 13 receives input from the traveler and provides information to the traveler by displaying the information. The input/output section 13 is for example a touch panel, operation keys, a display, or any combination thereof. The data communication I/F section 14 is an interface device for connection to the communication network 5.

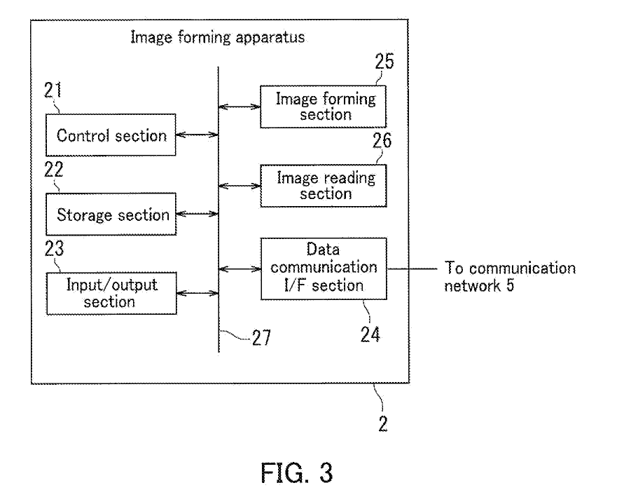

FIG. 3 is a configurational diagram illustrating an example of an image forming apparatus according to the embodiment.

The image forming apparatus 2 is for example a multifunction peripheral (MFP) that has at least two functions among functions of a scanner, a copier, a printer, and a facsimile machine (fax). The image forming apparatus 2 includes a control section 21, a storage section 22, an input/output section 23 (input section), a data communication I/F section 24 (terminal transmission section), an image forming section 25 (printing section), and an image reading section 26. The control section 21, the storage section 22, the input/output section 23, the data communication I/F section 24, the image forming section 25, and the image reading section 26 are connected to one another via an internal bus 27.

The control section 21 controls operation of the image forming apparatus 2. The storage section 22 includes ROM, RAM, and a secondary storage device. The secondary storage device is for example a non-volatile storage device such as a hard disk or flash memory. The input/output section 23 is a device that implements functions of input and output. The input/output section 23 receives input from the traveler and provides information to the traveler by displaying the information. The input/output section 23 is for example a touch panel, operation keys, a display, or any combination thereof. The data communication I/F section 24 is an interface device for connection to the communication network 5. The image forming section 25 is a device that implements a function of image formation. The image forming section 25 forms an image based on image data under the control of the control section 21. For example, the image forming section 25 forms an image based on guidebook data. The image reading section 26 is a device that implements a function of a scanner. The image reading section 26 reads an image and generates image data indicating the read image under the control of the control section 21.

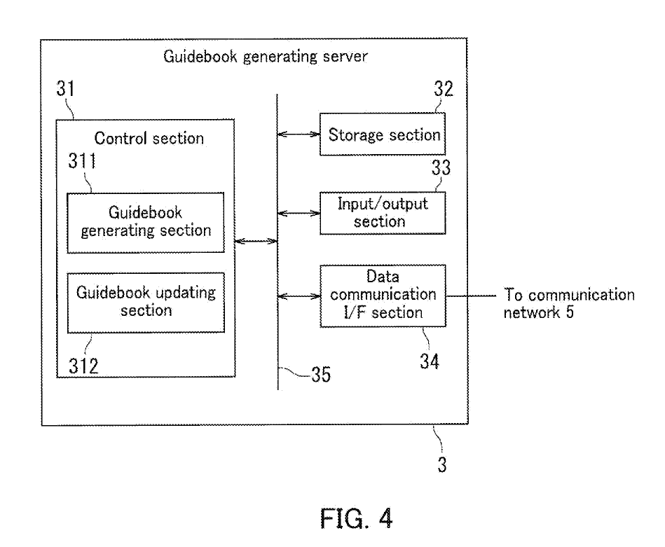

FIG. 4 is a configurational diagram illustrating an example of a guidebook generating server according to the embodiment.

The guidebook generating server 3 includes a control section 31, a storage section 32, an input/output section 33, a data communication I/F section 34 (server transmission section and server reception section). The control section 31, the storage section 32, the input/output section 33, and the data communication I/F section 34 are connected to one another via an internal bus 35.

The control section 31 controls operation of the guidebook generating server 3. The control section 31 includes a guidebook generating section 311 (guidebook data generating section) and a guidebook updating section 312 (guidebook data updating section). The guidebook generating section 311 prepares one or more travel plans that are appropriate for the traveler based on basic information and characteristic information received from the terminal 10, and based on reference information 41 acquired from the one or more information providing servers 4. Note that the basic information and the characteristic information are explained further below. The guidebook generating section 311 generates guidebook data of a guidebook indicating each of the travel plans prepared thereby. The guidebook updating section 312 determines whether or not the content of information that is included in the guidebook data from among the reference information 41 (herein the information included in the guidebook data is referred to as “specific reference information”) has changed in the information providing server 4 from which the specific reference information was provided. In a situation in which a change has occurred in the specific reference information, the guidebook updating section 312 updates the guidebook data based on the content of the specific reference information after the change.

Functions of the control section 31, the guidebook generating section 311, and the guidebook updating section 312 are implemented through the control section 31 executing various computer programs that are loaded in the RAM from the ROM. Note that instead of the functions of the guidebook generating section 311 and the guidebook updating section 312 being implemented through software, the guidebook generating server 3 may include hardware that implements the aforementioned functions.

The storage section 32 includes ROM, RAM, and a secondary storage device. The secondary storage device is for example a non-volatile storage device such as a hard disk or flash memory. The secondary storage device (referred to below simply as a “storage device”) of the storage section 32 stores basic information and characteristic information received from the terminal 10. The storage device also stores guidebook data generated by the guidebook generating section 311. The input/output section 33 is a device that implements functions of input and output. The input/output section 33 is for example a touch panel, operation keys, a display, or any combination thereof. The data communication I/F section 34 is an interface device for connection to the communication network 5.

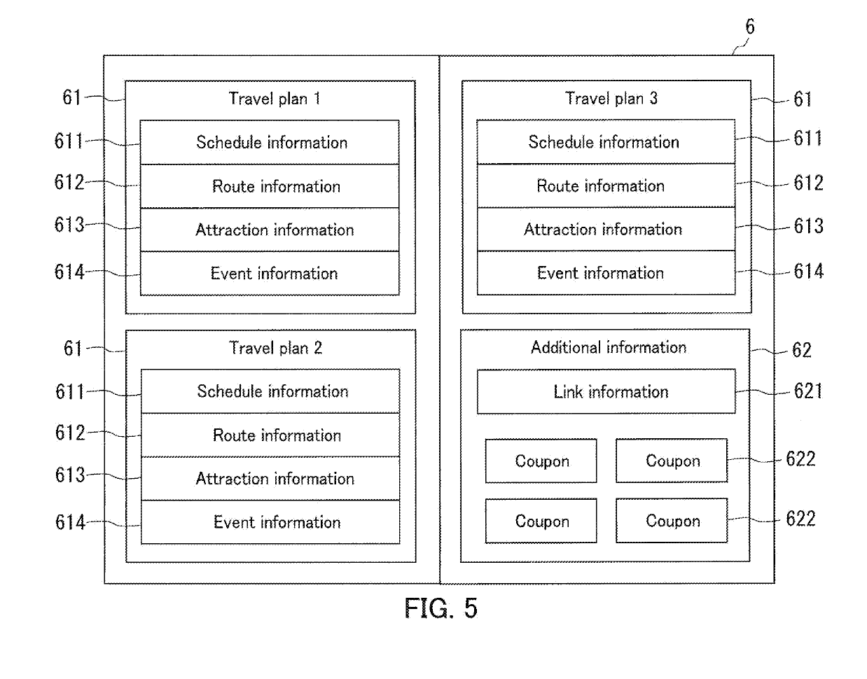

FIG. 5 is a configurational diagram illustrating an example of a guidebook according to the embodiment.

FIG. 5 conceptually illustrates a guidebook 6 as displayed or printed by the terminal 10. Although names of information included in the guidebook 6 are shown in the guidebook 6 illustrated in FIG. 5, in reality content of the information is indicated by, for example, text, diagrams, photographs, or any combination thereof. As illustrated in FIG. 5, the guidebook 6 includes travel plan information 61 indicating one or more travel plans and additional information 62 related to the travel plans. The guidebook 6 is for example configured such that when printed on an A4 sheet, the text, diagrams, and/or photographs included in the guidebook 6 are of a size that is easily visible to the traveler. The information included in the guidebook 6 is for example an amount that can fit onto one or two A4 sheets and hence is relatively simple compared to commercially available guidebooks.

Each set of travel plan information 61 for example includes schedule information 611, route information 612, attraction information 613, and event information 614. The schedule information 611 indicates a schedule of a corresponding travel plan. The schedule information 611 for example includes information indicating a visitation order and visitation times of one or more attractions that the traveler is scheduled to visit in the corresponding travel plan (referred to below as “visitation attractions”). The route information 612 is information indicating a travel route of the corresponding travel plan (referred to below as a “corresponding travel route”). The route information 612 for example includes information indicating a map that includes the corresponding travel route. The route information 612 may further include information indicating methods by which the traveler can move along the corresponding travel route and/or amounts of time required to move along the corresponding travel route by the aforementioned methods. The attraction information 613 indicates one or more visitation attractions that are present along the corresponding travel route. The event information 614 indicates one or more events that are to be held at the visitation attractions during a travel period.

The additional information 62 for example includes link information 621 and coupon information 622. The link information 621 is information indicating a provider of reference information 41 included in the travel plan information 61 (i.e., the specific reference information) and is for example a uniform resource locator (URL) for accessing a Web page including the specific reference information. The coupon information 622 is information for acquiring a coupon that is useable at a visitation attraction and is for example a QR code (registered Japanese trademark) for accessing a Web page from which the coupon can be acquired. Note that instead of the coupon information 622, the guidebook 6 may include a coupon that is in itself usable.

The guidebook 6 may include other information either in addition to or instead of the information illustrated in FIG. 5. For example, the guidebook 6 may include information indicating the weather during the travel period at locations related to the trip. The locations related to the trip include the start point, the final destination point, and a location along the travel route.

The following provides detailed explanation of processes performed by the information processing system 100. The processes performed by the information processing system 100 include a guidebook generation process, a guidebook reacquisition process, and a guidebook update process. In the guidebook generation process, the guidebook generating server 3 generates guidebook data indicating a guidebook 6 that is appropriate for the traveler, based on a request from the terminal 10. The terminal 10 then acquires the guidebook data from the guidebook generating server 3 and displays or prints the guidebook 6 based on the guidebook data. In the guidebook reacquisition process, the terminal 10 reacquires guidebook data from the guidebook generating server 3 and displays or prints a guidebook 6 based on the reacquired guidebook data. In the guidebook update process, upon a change occurring in content of specific reference information, the guidebook generating server 3 updates guidebook data based on the content of the specific reference information after the change. The terminal 10 then acquires the updated guidebook data from the guidebook generating server 3 and displays or prints a guidebook 6 based on the updated guidebook data. In the present embodiment, the guidebook reacquisition process and the guidebook update process are performed after the guidebook generation process.

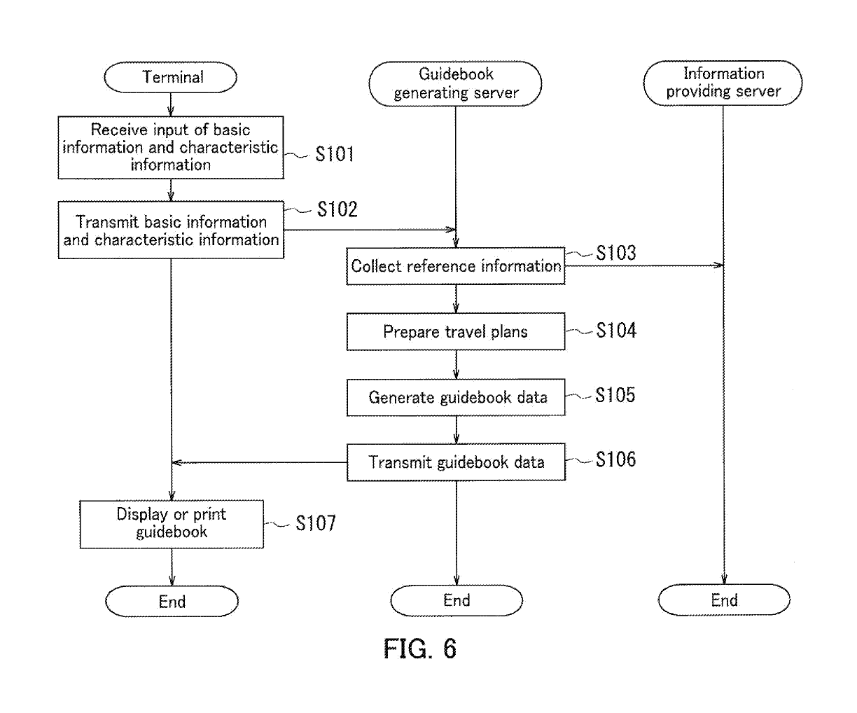

FIG. 6 is a flowchart illustrating a first example of the guidebook generation process according to the embodiment. In the first example of the guidebook generation process, the terminal 10 is a mobile terminal 1 or an image forming apparatus 2.

First, the terminal 10 receives input of basic information and characteristic information from the traveler via the input/output section 13 or 23 (Step S101).

The basic information is fundamental information pertaining to a trip. The basic information for example includes information indicating a start point, information indicating a final destination point, and information indicating a travel period. The characteristic information is information indicating one or more characteristics of the traveler. The characteristic information for example includes age information indicating the age of the traveler, gender information indicating the gender of the traveler, and interests information indicating hobbies or tastes (referred to below as “interests”) of the traveler. In a situation in which the traveler is a travel group including a plurality of travelers, in addition to age information, gender information, and interests information for each of the travelers, the characteristic information may also include group size information indicating the number of travelers in the travel group and gender ratio information indicating the ratio of male to female travelers in the travel group. The interests information for example includes the name of a food that the traveler likes, the name of a cartoon, film, or drama that the traveler is interested in, or the name of a genre of any of the above. The interests information for example also includes information indicating whether or not the traveler is interested in history and information indicating whether or not the traveler is interested in art.

Next, the control section 11 or 21 of the terminal 10 controls the data communication I/F section 14 or 24 to transmit the input basic information and characteristic information to the guidebook generating server 3 via the communication network 5 (Step S102).

Once the guidebook generating server 3 has received the basic information and the characteristic information, the guidebook generating section 311 of the guidebook generating server 3 stores the received basic information and characteristic information in the storage device. Next, the guidebook generating section 311 performs Steps S103 to S105 of the process explained below, thereby generating guidebook data of a guidebook 6 for display or printing by the terminal 10.

In the aforementioned steps, the guidebook generating section 311 first accesses one or more of the information providing servers 4, via the communication network 5, and collects reference information 41 from the information providing servers 4 (Step S103). Note that although the flowcharts only illustrate a single information providing server 4, a plurality of information providing servers 4 may be present.

The guidebook generating section 311 for example acquires, as the reference information 41, an area map of the start point and the final destination point indicated by the basic information and information indicating a map including all or part of a plurality of candidate travel routes. The guidebook generating section 311 also acquires, as the reference information 41, information indicating attractions located along the candidate travel routes (referred to below as “candidate attractions”). The guidebook generating section 311 also acquires, as the reference information 41, information indicating events that are to be held at the candidate attractions during the travel period. The guidebook generating section 311 also acquires information indicating the weather at a location of the trip during the travel period.

Next, the guidebook generating section 311 prepares one or more travel plans that are appropriate for the traveler based on the basic information and the characteristic information received from the terminal 10, and based on the reference information 41 acquired from the information providing servers 4 (Step S104). More specifically, the guidebook generating section 311 prepares one or more travel plans that are each appropriate for characteristics of the traveler indicated by the characteristic information, and that start with departure from the start point on a start date of the travel period and end with arrival at the final destination point on an end date of the travel period. The guidebook generating section 311 prepares each of the travel plans by using the start point, the final destination point, and the travel period indicated by the basic information as respectively a start point, a final destination point, and a travel period of the travel plan. The following explains an example of how the guidebook generating section 311 prepares a travel plan that is appropriate for the characteristics of the traveler.

The guidebook generating section 311 selects an attraction that is appropriate for the characteristics indicated by the characteristic information from among a plurality of candidate attractions. For example, in a configuration in which the characteristic information includes age information, gender information, and interests information, the guidebook generating section 311 selects an attraction that is appropriate for the age, gender, and interests of the traveler. The guidebook generating section 311 for example performs the aforementioned selection based on a first correspondence table in which correspondence between the characteristics of the traveler and attractions appropriate for such characteristics is predefined. The first correspondence table is for example stored in the storage device. For example, a correspondence between a traveler being interested in history and an attraction related to a historical building or a historically significant person may be predefined in the first correspondence table. Therefore, in a situation in which the traveler is interested in history, the guidebook generating section 311 selects an attraction that corresponds to the traveler being interested in history, which in other words is an attraction related to a historical building or a historically significant person. In another example, a correspondence between the traveler being a travel group including a child and an attraction that is enjoyable for children, such as an amusement park or a zoo, may be predefined in the first correspondence table. Therefore, when the traveler is a family including a child, the guidebook generating section 311 selects an attraction that corresponds to the traveler being a travel group including a child, which in other words is for example an amusement park or a zoo. After selecting one or more attractions, the guidebook generating section 311 selects a travel route passing the selected attractions from among a plurality of candidate travel routes and determines the selected travel route to be a travel route of the travel plan. The guidebook generating section 311 subsequently determines a visitation order and visitation times for selected attractions based on the selected attractions, the travel route, and the reference information 41. In other words, the guidebook generating section 311 determines a schedule for the travel plan.

Next, the guidebook generating section 311 generates guidebook data of a guidebook 6 indicating each of one or more travel plans prepared in Step S104 (Step S105). More specifically, based on the reference information 41, the guidebook generating section 311 generates travel plan information 61 indicating each of the travel plans prepared in Step 104 and additional information 62 related to the travel plans, and generates guidebook data including the travel plan information 61 and the additional information 62 that is generated.

Next, the guidebook generating section 311 controls the data communication I/F section 34 to transmit the guidebook data that is generated in Step S105 to the terminal 10 via the communication network 5 (Step S106).

Once the terminal 10 has received the guidebook data, the control section 11 or 21 of the terminal 10 causes display or printing of a guidebook 6 based on the received guidebook data (Step S107). For example, in a situation in which the terminal 10 is the mobile terminal 1, the control section 11 of the mobile terminal 1 controls the input/output section 13 to display the guidebook 6 based on the received guidebook data. On the other hand, in a situation in which the terminal 10 is the image forming apparatus 2, the control section 21 of the image forming apparatus 2 controls the image forming section 25 to print the guidebook 6 based on the received guidebook data.

During the above, the control section 21 of the image forming apparatus 2 may cause printing of the guidebook 6 according to a printing layout that is appropriate for the traveler based on the characteristic information that is input in Step S101. For example, the control section 21 determines a printing layout to be used during printing of the guidebook 6 based on a second correspondence table in which correspondence between characteristics of the traveler and printing layouts that are appropriate for the aforementioned characteristics is predefined. The second correspondence table is for example stored in the storage section 22 of the image forming apparatus 2. For example, in a configuration in which the characteristic information includes age information, the control section 21 may cause printing of the guidebook 6 according to a printing layout that is appropriate for the age of the traveler. When the traveler is for example an elderly person, the control section 21 may cause content of the guidebook 6, such as text, to be printed in a large size.

Through the guidebook generation process illustrated in FIG. 6, the traveler can acquire a guidebook 6 including travel plans that are appropriate for the traveler, simply by inputting basic information and characteristic information into the terminal 10. The traveler can also acquire a guidebook 6 that is printed according to a printing layout that is appropriate for the traveler.

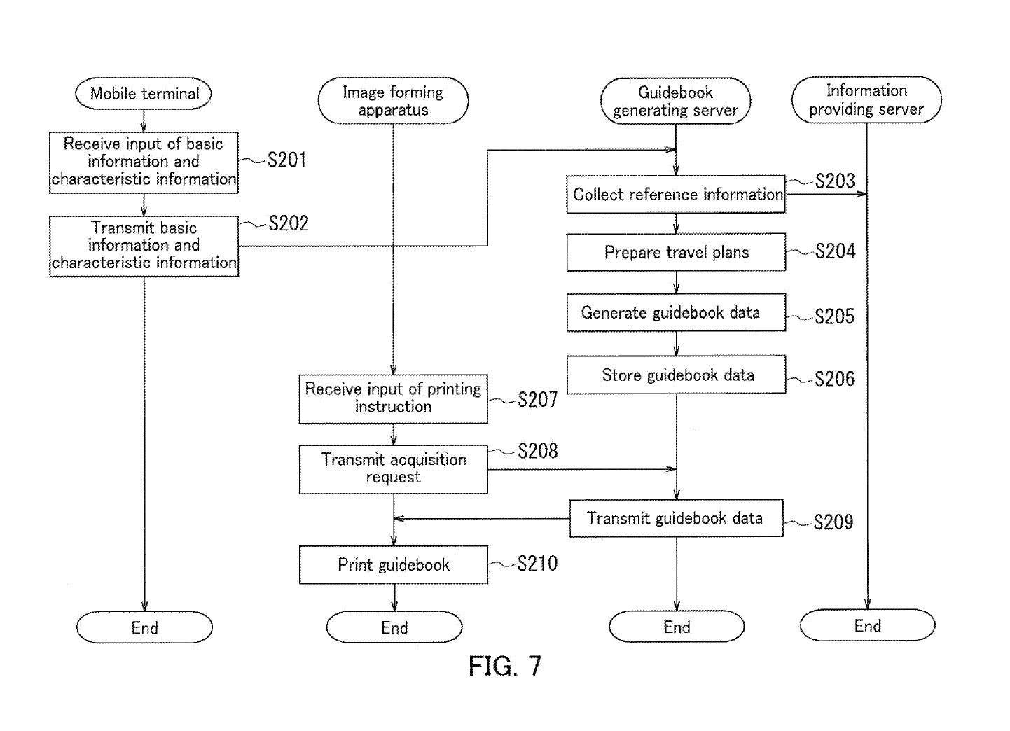

FIG. 7 is a flowchart illustrating a second example of a guidebook generation process according to the embodiment.

In the second example of the guidebook generation process, the information processing system 100 includes a mobile terminal 1 and an image forming apparatus 2 as terminals 10. The mobile terminal 1 is for example located at a location that is distant to a location of a trip. The image forming apparatus 2 is for example provided in a convenience store at, or in proximity to, a start point of the trip.

First, the mobile terminal 1 receives input of basic information and characteristic information from a traveler via the input/output section 13 (Step S201). Next, the control section 11 of the mobile terminal 1 controls the data communication I/F section 14 to transmit the input basic information and characteristic information to the guidebook generating server 3 via the communication network 5 (Step S202). In the second example of the guidebook generation process, the mobile terminal 1 receives input of the basic information and the characteristic information from the traveler and transmits the input basic information and characteristic information to the guidebook generating server 3 in advance of the trip.

Once the guidebook generating server 3 has received the basic information and the characteristic information, the guidebook generating section 311 of the guidebook generating server 3 stores the received basic information and characteristic information in the storage device. Next, the guidebook generating section 311 generates guidebook data by performing the same process as in Steps S103 to S105 of FIG. 6 (Steps S203 to S205).

After generating the guidebook data, the guidebook generating section 311 stores the generated guidebook data in the storage device (Step S206). In other words, the guidebook generating server 3 stores the generated guidebook data in the storage device until the guidebook generating server 3 receives an acquisition request for the guidebook data.

The image forming apparatus 2 receives input of a printing instruction for a guidebook 6 from the traveler via the input/output section 23 once the traveler has arrived at the location of the trip (Step S207).

Once the image forming apparatus 2 has received the printing instruction, the control section 21 of the image forming apparatus 2 controls the data communication I/F section 24 to transmit an acquisition request for guidebook data to the guidebook generating server 3 via the communication network 5 (Step S208).

Once the guidebook generating server 3 has received the acquisition request for guidebook data, the control section 31 of the guidebook generating server 3 controls the data communication I/F section 34 to transmit the guidebook data that is stored in the storage device in Step S206 to the image forming apparatus 2 via the communication network 5 (Step S209).

Once the image forming apparatus 2 has received the guidebook data, the control section 21 of the image forming apparatus 2 controls the image forming section 25 to print a guidebook 6 based on the received guidebook data (Step S210).

During the above, the image forming apparatus 2 may also receive, from the guidebook generating server 3, the characteristic information that the guidebook generating server 3 has received from the mobile terminal 1. Alternatively, the image forming apparatus 2 may receive input of characteristic information from the traveler via the input/output section 23. The control section 21 of the image forming apparatus 2 may then cause printing of a guidebook in accordance with a printing layout that is appropriate for the traveler based on the received characteristic information or the input characteristic information.

Through the guidebook generation process illustrated in FIG. 7, the traveler can use the mobile terminal 1, which is located at a different location to the trip, to input information required for generating a guidebook 6—namely basic information and characteristic information—in advance of the trip, and once the traveler has arrived at the location of the trip, the traveler can acquire the guidebook 6 by using an image forming apparatus provided at the location of the trip. The above enables the traveler to acquire the guidebook after arriving at the location of the trip, thereby eliminating necessity of the traveler having to prepare the guidebook in advance and having to carry the guidebook to the location of the trip.

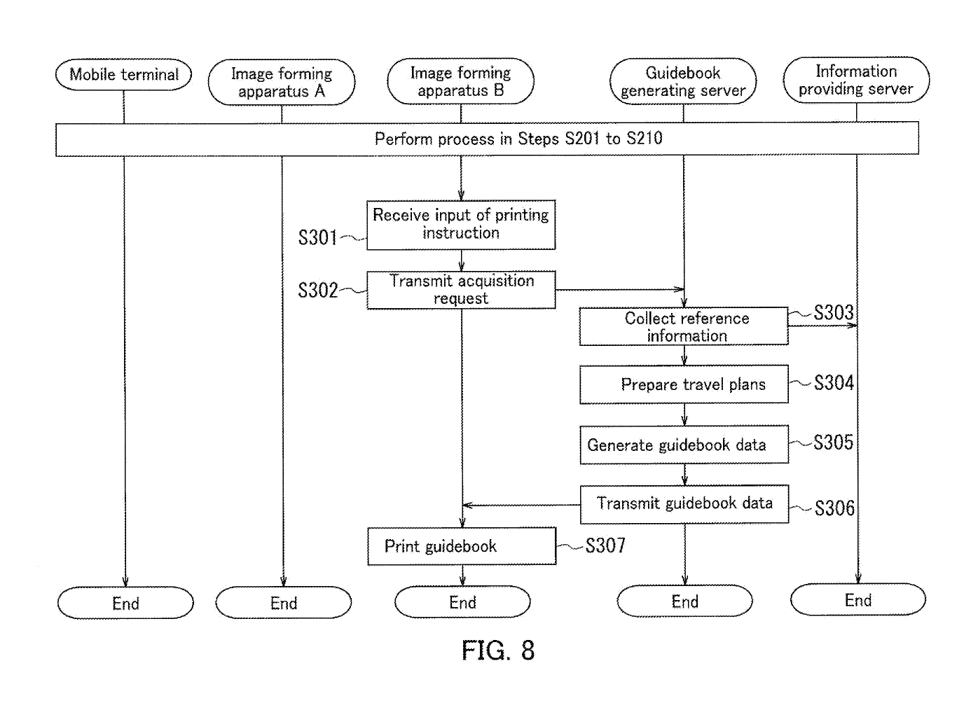

FIG. 8 is a flowchart illustrating a first example of a guidebook reacquisition process according to the embodiment.

The process illustrated in FIG. 8 is performed after the process illustrated in FIG. 7. In the first example of the guidebook reacquisition process, an image forming apparatus that has received input of a printing instruction from a traveler and that has printed a guidebook 6 according to the process illustrated in FIG. 7 is referred to as “image forming apparatus A”. An image forming apparatus that is located at a different location to the image forming apparatus A and that is for example provided in a convenience store along, or in proximity to, the travel route is referred to as “image forming apparatus B”.

After Steps S201 to S210 of the process illustrated in FIG. 7 have been performed, the image forming apparatus B receives input of a printing instruction for a guidebook 6 from the traveler via the input/output section 23 (Step S301). In other words, once the traveler has moved from the location of the image forming apparatus A to the location of the image forming apparatus B, the traveler once again requests acquisition of a guidebook 6, but this time with respect to the image forming apparatus B.

Once the image forming apparatus B has received the printing instruction, the control section 21 of the image forming apparatus B controls the data communication I/F section 24 to transmit an acquisition request for guidebook data to the guidebook generating server 3 via the communication network 5 (Step S302). The acquisition request includes location information indicating the location of the image forming apparatus B.

Once the guidebook generating server 3 has received the acquisition request for guidebook data, the guidebook generating section 311 of the guidebook generating server 3 generates guidebook data according to the same process as illustrated in Steps S103 to S105 of FIG. 6 (Steps S303 to S305). However, note that in the above situation the guidebook generating section 311 prepares travel plans using the location of the image forming apparatus B as a start point for each of the travel plans, instead of using the start point indicated by the basic information as the start point of each of the travel plans. Furthermore, the guidebook generating section 311 reacquires reference information 41 and prepares the travel plans based on the reacquired reference information 41, which in other words is up-to-date reference information 41 at the time of reacquisition, and based on the basic information and the characteristic information that are stored in the storage device. As a consequence, a guidebook 6 based on the guidebook data generated in Step S305 includes up-to-date travel plans from the current location of the traveler to the final destination point that have been prepared based on the up-to-date reference information 41. Note that the guidebook generating section 311 may generate new guidebook data from scratch or may generate updated guidebook data by updating the guidebook data that is stored in the storage device.

Next, the guidebook generating section 311 controls the data communication I/F section 34 to transmit the guidebook data that is generated in Step S305 to the image forming apparatus B via the communication network 5 (Step S306).

Once the image forming apparatus B has received the guidebook data, the control section 21 of the image forming apparatus B causes printing of a guidebook 6 based on the received guidebook data (Step S307). In the same way as in Step S210 of FIG. 7, the control section 21 may cause printing of the guidebook 6 according to a printing layout that is appropriate for the traveler based on characteristic information that is received from the guidebook generating server 3 or characteristic information that is input by the traveler.

Through the guidebook reacquisition process illustrated in FIG. 8, the traveler can acquire an up-to-date guidebook 6 during a trip in accordance with a degree of progress of the trip. In other words, the traveler can acquire a guidebook 6 that includes up-to-date travel plans from a current location of the traveler to the final destination point.

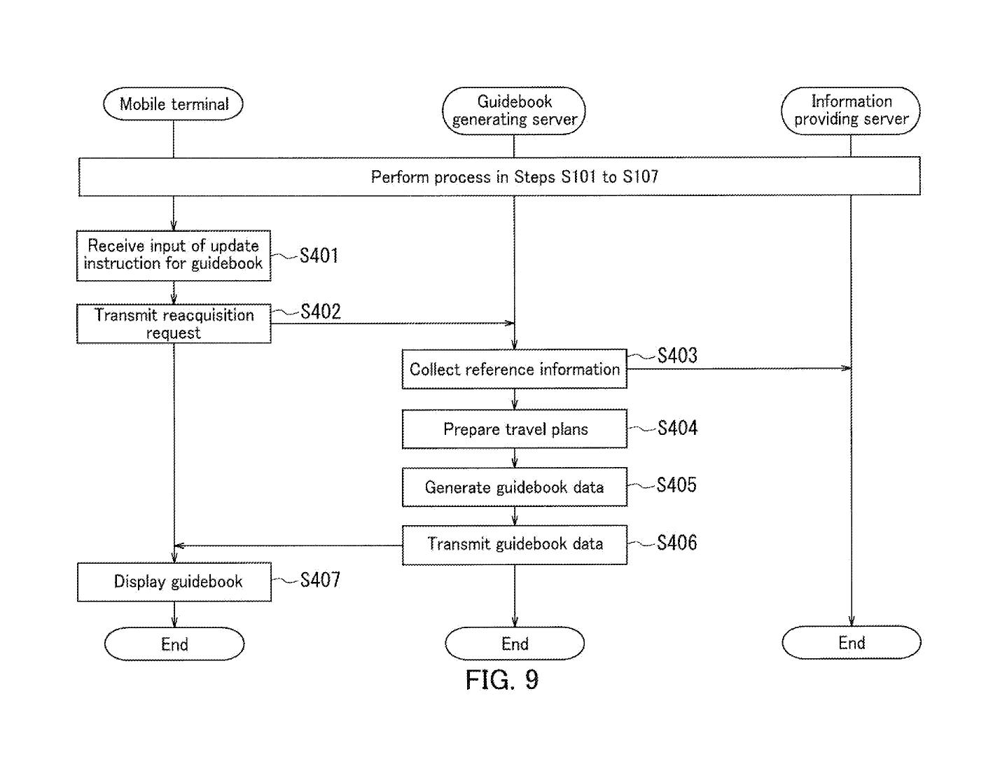

FIG. 9 is a flowchart illustrating a second example of a guidebook reacquisition process according to the embodiment.

The process illustrated in FIG. 9 is performed after the process illustrated in FIG. 6. In the second example of the guidebook reacquisition process, the terminal 10 is a mobile terminal 1 that is carried by a traveler during a trip.

After Steps S101 to S107 of the process illustrated in FIG. 6 have been performed, the mobile terminal 1 receives input of an update instruction for the guidebook 6 from the traveler via the input/output section 13 (Step S401).

Once the mobile terminal 1 has received the update instruction, the control section 11 of the mobile terminal 1 controls the data communication I/F section 14 to transmit a reacquisition request for guidebook data to the guidebook generating server 3 via the communication network 5 (Step S402). The reacquisition request includes location information indicating the location of the mobile terminal 1.

Once the guidebook generating server 3 has received the reacquisition request for guidebook data, the guidebook generating section 311 of the guidebook generating server 3 generates guidebook data according to the same process as illustrated in Steps S103 to S105 of FIG. 6 (Steps S403 to S405). However, note that in the above situation the guidebook generating section 311 prepares travel plans using the location of the mobile terminal 1 as a start point for each of the travel plans, instead of using the start point indicated by the basic information as the start point of each of the travel plans. Furthermore, the guidebook generating section 311 prepares the travel plans based on the basic information and the characteristic information that are stored in the storage device, and based on up-to-date reference information 41. In other words, in the same way as in Step S305 of FIG. 8, in Step S405 guidebook data is generated of a guidebook 6 indicating up-to-date travel plans from a current location of the traveler to the final destination point that have been prepared based on the up-to-date reference information 41. Note that the guidebook generating section 311 may generate up-to-date guidebook data by generating new guidebook data from scratch or by storing the guidebook data that is generated in Step S105 of FIG. 6 in the storage device and subsequently updating the stored guidebook data.

Next, the guidebook generating section 311 controls the data communication I/F section 34 to transmit the guidebook data that is generated in Step S405 to the mobile terminal 1 via the communication network 5 (Step S406).

Once the mobile terminal 1 has received the guidebook data, the control section 11 of the mobile terminal 1 controls the input/output section 13 to display a guidebook 6 based on the received guidebook data (Step S407).

Through the guidebook reacquisition process illustrated in FIG. 9, the traveler can acquire a guidebook 6 during a trip that includes up-to-date travel plans in accordance with a degree of progress of the trip. In other words, the traveler can acquire a guidebook 6 including up-to-date travel plans that are each from a current location of the traveler to the final destination point. Furthermore, the traveler can acquire up-to-date guidebook data using the mobile terminal 1 carried thereby, and can therefore acquire and view an up-to-date guidebook 6 at any time and at any location desired by the traveler.

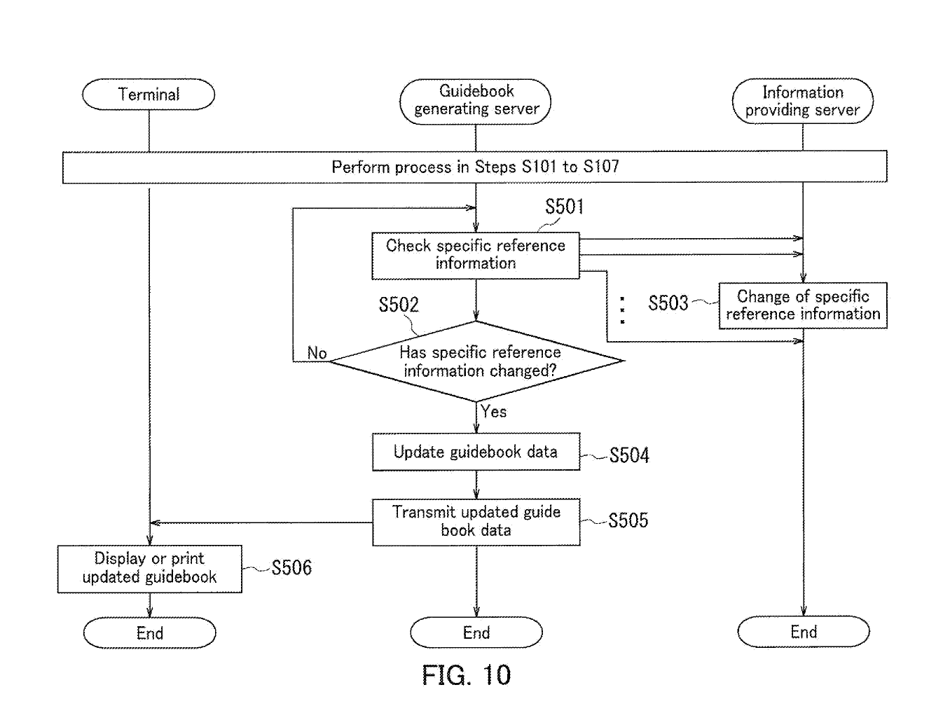

FIG. 10 is a flowchart illustrating a guidebook update process according to the embodiment.

The process illustrated in FIG. 10 is performed after the process illustrated in FIG. 6. Note that in the process illustrated in FIG. 6, the guidebook generating section 311 of the guidebook generating server 3 stores guidebook data that is generated in Step S105 in the storage device.

After Steps S101 to S107 of the process illustrated in FIG. 6 have been completed, the guidebook updating section 312 of the guidebook generating server 3 either periodically or non-periodically accesses an information providing server 4 that has provided reference information 41 included in the guidebook data stored in the storage device, which in other words is specific reference information, and thereby determines whether or not a change has occurred in content of the specific reference information in the information providing server 4 (Steps S501 and S502).

When a change has occurred in the content of the specific reference information (Step S502: Yes), the guidebook updating section 312 updates the guidebook data that is stored in the storage section based on the content of the specific reference information after the change (Step S504).

The guidebook updating section 312 then controls the data communication I/F section 34 to transmit the guidebook data that has been updated in Step S504 to the terminal 10 (Step S505).

Once the terminal 10 has received the guidebook data, the control section 11 or 21 of the terminal 10 causes printing or display of a guidebook 6 based on the received guidebook data (Step S506).

Through the guidebook update process illustrated in FIG. 10, in a situation in which specific reference information that is included in guidebook data changes in an information providing server 4 that originally provided the specific reference information, guidebook data that has been updated based on changed content of the specific reference information is notified to the terminal 10, thereby enabling the traveler to view a guidebook 6 that is always based on up-to-date reference information 41.

According to the present embodiment, the guidebook generating server 3 generates guidebook data indicating a guidebook 6 that is appropriate for a traveler based on basic information and characteristic information input by the traveler using the terminal 10, and transmits the generated guidebook data to the terminal 10. The terminal 10 receives the guidebook data and provides the guidebook 6 to the traveler by displaying or printing the guidebook 6 based on the received guidebook data. Therefore, the traveler can acquire a guidebook 6 including travel plans that are appropriate for the traveler simply by inputting basic information and characteristic information into the terminal 10. As a consequence, the information processing system 100 including the terminal 10 and the guidebook generating server 3 can provide the traveler with a guidebook that is appropriate for the traveler either prior to a trip or during the trip.

Although one embodiment of the present disclosure is described above, the present disclosure is of course not limited to the above embodiment and a wide range of variations are possible so long as such variations do not deviate from the intended scope of the present disclosure.

The terminal 10 is described in the present embodiment using the mobile terminal 1 and the image forming apparatus 2 as examples, but the terminal 10 is not limited to the mobile terminal 1 and the image forming apparatus 2, and may be any other apparatus that has functions of input and output and that is communicable with the guidebook generating server 3 via the communication network 5.

What is claimed is:

1. An information processing system comprising:
at least one terminal used by a traveler;
a first server that is communicable with the terminal and that generates guidebook data of a guidebook for display or printing by the terminal; and
at least one second server that is communicable with the first server and that provides reference information for reference during generation of the guidebook data, wherein
the first server includes
a server reception section that receives, from the terminal, basic information pertaining to a trip being planned by the traveler and characteristic information indicating a characteristic of the traveler,
a guidebook data generating section that prepares one or more travel plans for the trip that are appropriate for the traveler based on the basic information and the characteristic information received from the terminal, and based on the reference information acquired from the second server, and that generates guidebook data of a guidebook indicating each of the travel plans, and
a server transmission section that transmits the guidebook data generated by the guidebook data generating section to the terminal.

2. An information processing system according to claim 1, wherein
the basic information includes information indicating a start point, a final destination point, and a travel period of the trip,
the characteristic information includes information indicating an age, a gender, and an interest of the traveler,
the guidebook includes, for each of the travel plans, at least one among information indicating a route from the start point to the final destination point, information indicating one or more tourist attractions along the route, information indicating an order and times for visiting the tourist attractions, and information indicating one or more events being held at the tourist attractions during the travel period, and
each of the travel plans prepared by the guidebook data generating section starts with departure from the start point on a start date of the travel period and ends with arrival at the final destination point on an end date of the travel period, and is appropriate for the age, the gender, and the interest of the traveler.

3. An information processing system according to claim 1, wherein
the terminal is an image forming apparatus including
a first input section that receives input of the basic information and the characteristic information,
a first terminal transmission section that transmits the basic information and the characteristic information to the first server, and
a printing section that prints the guidebook based on the guidebook data received from the first server.

4. An information processing system according to claim 1, wherein
the at least one terminal is a plurality of terminals including a first terminal and a second terminal that is an image forming apparatus,
the first terminal includes
a first input section that receives input of the basic information and the characteristic information, and
a first terminal transmission section that transmits the basic information and the characteristic information to the first server, and
the second terminal includes
a second input section that receives input of a printing instruction with respect to the guidebook, and
a printing section that upon input of the printing instruction, prints the guidebook based on the guidebook data received from the first server.

5. An information processing system according to claim 4, wherein
the second terminal is provided at a location along a route between a start point and a final destination point of the trip,
the second terminal further includes a second terminal transmission section that upon input of the printing instruction, transmits an acquisition request to the first server that requests acquisition of guidebook data and that includes location information indicating the location of the second terminal, and
the guidebook data generating section, upon the acquisition request being received by the first server, generates guidebook data of a guidebook indicating one or more travel plans for a trip having the location of the second terminal as a start point thereof.

6. An information processing system according to claim 3, wherein
the printing section prints the guidebook according to a printing layout that is appropriate for the traveler based on the characteristic information.

7. An information processing system according to claim 1, wherein
the terminal is a mobile terminal including
a first input section that receives input of the basic information and the characteristic information,
a first terminal transmission section that transmits the basic information and the characteristic information to the first server, and
a displaying section that displays the guidebook based on the guidebook data received from the first server.

8. An information processing system of claim 7, wherein
the first input section receives input of an update instruction with respect to the guidebook,
the first terminal transmission section, upon the update instruction being input, transmits a reacquisition request to the first server that requests reacquisition of guidebook data and that includes location information indicating a location of the terminal, and
the guidebook data generating section, upon the reacquisition request being received by the first server, generates guidebook data of a guidebook indicating one or more travel plans for a trip having the location of the terminal as a start point thereof.

9. An information processing system according to claim 1, wherein
the first server further includes
a storage section that stores the guidebook data generated by the guidebook data generating section,
a determining section that determines whether or not a change has occurred in content of specific reference information in the second server, the specific reference information being information included in the guidebook data from among the reference information acquired from the second server, and
a guidebook data updating section that upon the determining section determining that the change has occurred, updates the guidebook data stored in the storage section based on the content of the specific reference information after the change and controls the server transmission section to transmit the guidebook data that has been updated to the terminal.

10. An information processing system according to claim 1, wherein
the guidebook data generating section selects, from among information indicating a plurality of candidate tourist attractions, information indicating a tourist attraction that is appropriate for the characteristic of the traveler indicated by the characteristic information.

11. An information processing system according to claim 10, wherein
the guidebook data generating section selects, from among a plurality of candidate routes that are each from a start point to a final destination point of the trip, a route that passes the tourist attraction that is selected as appropriate for the characteristic of the traveler, and determines the route that is selected to be a route of a travel plan.

12. An information processing system according to claim 2, wherein
the guidebook data generating section acquires information indicating weather during the travel period at the start point, the final destination point, and a location between the start point and the final destination point along the route of the travel plan.

13. A server that is communicable with at least one terminal used by a traveler and that generates guidebook data of a guidebook for display or printing by the terminal, the server comprising:
a reception section that receives, from the terminal, basic information pertaining to a trip being planned by the traveler and characteristic information indicating a characteristic of the traveler;
a guidebook data generating section that prepares one or more travel plans for the trip that are appropriate for the traveler based on the basic information and the characteristic information received from the terminal, and based on reference information acquired from at least one external server, and that generates guidebook data of a guidebook indicating each of the travel plans; and
a transmission section that transmits the guidebook data generated by the guidebook data generating section to the terminal.

14. An image forming apparatus comprising:
an input section that receives input of basic information pertaining to a trip being planned by a traveler and characteristic information indicating a characteristic of the traveler;
a transmission section that transmits the basic information and the characteristic information to a first server;
a reception section that receives, from the first server, guidebook data of a guidebook indicating one or more travel plans that are appropriate for the traveler and that have been prepared by the first server based on the basic information and the characteristic information, and based on reference information acquired from at least one second server; and
a printing section that prints the guidebook based on the guidebook data that is received.
